(19) United States
(12) Patent Application Publication
(10) Pub. No.: US 2008/0092748 A1
(43) Pub. Date: Apr. 24, 2008

(54) Apparatus for Brewing Beverages

(76) Inventor: Matthew Francis Reid, London (GB)

Correspondence Address: Lloyd L. Zickert, 79 West Monroe Street, Chicago, IL, 60603, US

(21) Appl. No.: 11/665,518

(22) PCT Filed: Oct. 21, 2005
(86) PCT No.: PCT/GB05/04096

§ 371 Date: Apr. 12, 2007

(30) Foreign Application Priority Data
Oct. 22, 2004 (GB) 0423539.6

(51) Int. Cl. A47J 31/20

(52) U.S. Cl. 99/297

(57) ABSTRACT

There is provided an apparatus for brewing beverages comprising; an upper vessel part; a lower vessel part; a watertight joint whereby the upper and lower vessel parts can be releasably assembled into a unified vessel, the vessel having an open upper end and a closed lower end; so that when assembled, the vessel can receive and retain fluid therein; and a plunger apparatus comprising; a filter apparatus; and a plunger arm; wherein the plunger arm and filter apparatus are joined or can be joined, so that the filter apparatus can be pushed into the vessel via the plunger arm; and the filter apparatus is adapted to fit into and seal against the inside of the vessel, so that when pushed into the vessel the filter apparatus forms a barrier across the inside of the vessel.

### FIELD OF THE INVENTION

The present invention relates to an apparatus for brewing beverages.

### BACKGROUND AND DISCUSSION OF THE PRIOR ART

The background of the invention will be discussed in relation to cafetiere style brewing apparatuses comprising an elongate vessel for holding a mixture of typically hot water and solid matter, and a filter attached to a plunger for filtering the solid material out of the hot water.

When preparing a beverage using a known cafetiere, solid matter, such as ground coffee, is introduced to the vessel followed by freshly boiled water. The mixture is allowed to brew for a time period and then the filter, which seals against the inside wall of the vessel, is pushed from the top of the vessel, through the mixture, filtering out solid material. The beverage is then poured out of the vessel and a residue comprising water and solid matter is left trapped beneath the filter.

A problem with known cafetieres is that the distance their filters can be pushed into their vessels is restricted by the presence of a lid so that when the filter is pushed fully into the vessel there is a space left between the filter and the base of the vessel. Because of this the residue is often too fluid to conveniently dispose of it in a rubbish bin. In addition to this, if poured down a drain, it is likely to cause a blockage because the residue contains insoluble matter. Hence there is a problem associated with disposal of the residue left in known cafetieres.

It is disadvantageous to solve this problem by provision of a cafetiere without a lid because the lid is useful in preventing spillages, guiding the plunger into the vessel and in keeping the beverage warm.

The invention seeks to alleviate the above problem at least.

### SUMMARY OF THE INVENTION

According to one aspect of the present invention there is provided an apparatus for brewing beverages comprising;

an upper vessel part;

a lower vessel part;

a watertight joint whereby the upper and lower vessel parts can be releasably assembled into a unified vessel, the vessel having an open upper end and a closed lower end; so that when assembled, the vessel can receive and retain fluid therein; and

a plunger apparatus comprising;

a filter apparatus; and

a plunger arm; wherein

the plunger arm and filter apparatus are joined or can be joined so that the filter apparatus can be pushed into the vessel via the plunger arm; and

the filter apparatus is adapted to fit into and seal against the inside of the vessel, so that when pushed into the vessel the filter apparatus forms a barrier across the inside of the vessel.

By providing a vessel which can be split into upper and lower parts, once the residue has been left in the base, the top of the vessel can be removed allowing the plunger apparatus to be pushed further into the vessel, squeezing enough water out of the residue so that it is compacted into a more solid mass. The residue can then be disposed of in a bin because it is no longer too fluid.

Removing the upper part of the vessel also allows easier access to the base of the vessel so that when the residue has been pressed to a more solid lump it can be easily removed using a teaspoon or the like. This is important because after pressing, the residue may be so compacted into the base of the vessel that it cannot be adequately removed by merely shaking or knocking the vessel.

According to a second aspect of the invention there is provided an apparatus for brewing beverages comprising;

a vessel adapted to retain fluid therein and having an open upper end;

a plunger apparatus comprising;

a filter apparatus;

a plunger arm; and

a lid through which the plunger arm passes; wherein

the plunger arm and filter apparatus are joined or can be joined, so that the filter apparatus can be pushed into the vessel via the plunger arm; and
   the filter apparatus is adapted to fit into and seal against the inside of the vessel, so that when pushed into the vessel the filter apparatus forms a barrier across the inside of the vessel; and
   a lid through which the plunger arm passes;
   the lid is adapted so that it can be removed from the plunger arm without disassembly of the filter apparatus and the plunger arm so that when the lid is removed from the plunger arm the plunger apparatus can be pushed into contact with the lower end of the vessel via the plunger arm.

Preferably the lid completely covers the open upper end of the vessel, however, the lid may also be adapted to only partially cover the open end of the vessel and/or to be a skeletal structure.

The above arrangement is used in a manner similar to known cafetieres, up to the point where the beverage has been poured out of the vessel and a residue is left in the cafetiere trapped by the filter. As discussed above, with known cafetieres the user is then presented with the problem of disposal associated with the residue. The current invention addresses the problem by disengaging the element which restricts the inward movement of the plunger arm, from the plunger arm allowing the arm to move further into the cafetiere, pushing the filter apparatus further into the residue and hence squeezing enough water out of the residue to make it more solid and manageable for disposal.

### BRIEF DESCRIPTION OF THE DRAWINGS

Embodiments of the invention will be described by way of non-limiting example by reference to the accompanying figures of which;

FIG. 1 is a perspective view showing detached upper and lower parts of a cafetiere vessel;

FIG. 2 is sectional view of a joint for attaching upper and lower parts of a cafetiere vessel;

FIG. 3 is a perspective view of the joined upper and lower parts shown in FIG. 1;

FIG. 4 is a front elevation of a plunger apparatus for use in a cafetiere;

FIG. 5 is a front elevation of a cafetiere;

FIG. 6 is a perspective view of a lower vessel part of a cafetiere and a plunger arm during use;

FIG. 7 is a perspective view of a vessel for use in a cafetiere;

FIG. 8 is a front elevation of a cafetiere;

FIGS. 9a and b are plan views of a cafetiere vessel with lid closed and open respectively;

FIG. 10 is a front elevation of a cafetiere with internal detailing;

FIG. 11 is a side elevation of a cafetiere with an open lid;

FIG. 12 is a front elevation of a cafetiere with internal detailing;

FIG. 13 is a side elevation of a cafetiere with an open lid;

FIG. 14 is a perspective view of a vessel of a cafetiere and a plunger arm during use.

### DETAILED DESCRIPTION

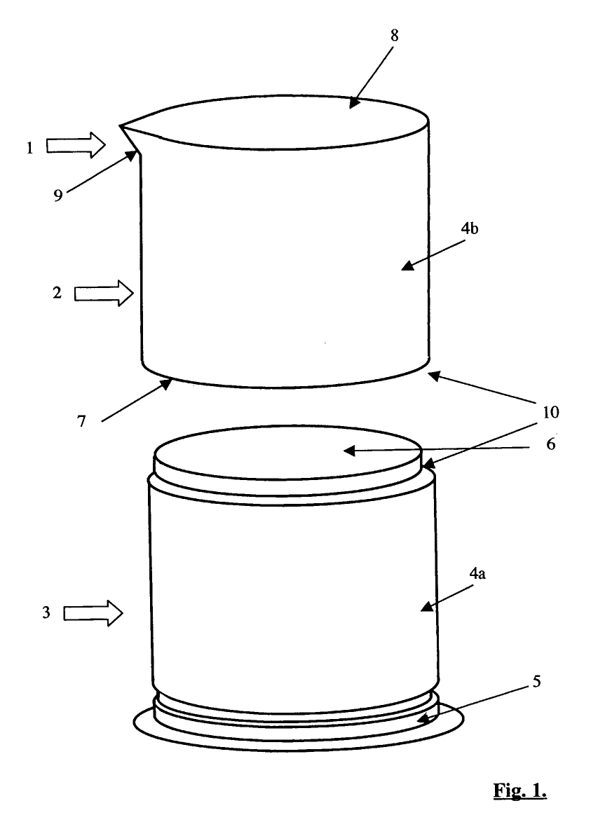

Referring to FIG. 1 there is provided a vessel 1 comprising an upper vessel part 2 and a lower vessel part 3.

The lower vessel part 3 comprises a side wall 4a, a closed base 5 and an open upper end 6.

The upper vessel part 2 comprises a side wall 4b, an open lower end 7 and an open upper end 8. Preferably the upper vessel part 2 comprises a spout portion 9 adapted to aid controllable pouring of fluid from the open upper end 8 of the upper vessel part 2.

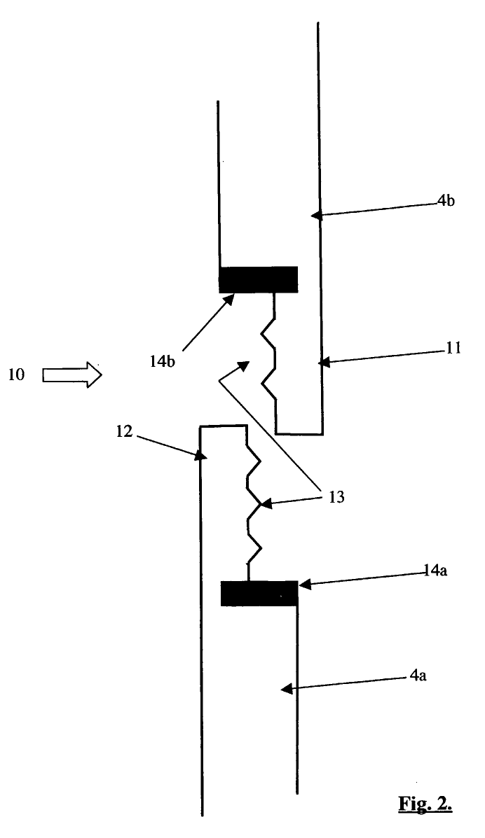

Referring now to FIGS. 1 and 2, a watertight joint 10 is provided by which the lower vessel part 3 and the upper vessel part 2 can be assembled forming a unified vessel 1.

In a preferred embodiment the joint comprises a downward extension 11 of the side wall 4b of the upper vessel part 2 and an upward extension 12 of the side wall 4a of the lower vessel part 3. The two extensions 11, 12 are preferably provided with complementary screw threads 13 for screwing the upper vessel part 2 together with the lower vessel part 3. A first washer 14b is located on the lower end of the side wall 4b and a second washer 14a is located on the upper end of the side wall 4a. The washers 14a, 14b are placed to engage the outer ends of the side wall extensions 11, 12 to produce a watertight seal when the upper and lower vessel parts are assembled.

Preferably the washers are rubber however it will be clear to those skilled in the art that other materials may be used.

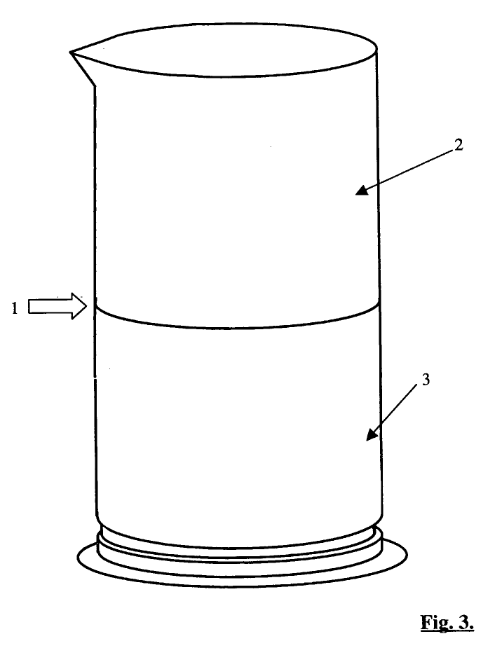

When assembled into a unified vessel 1 as shown in FIG. 3, the vessel 1 is able to receive and retain fluid.

The watertight joint 10 can be located at a number of heights on the unified vessel. It is preferably located no more than substantially half of the way up the height of the unified vessel. It is further preferably located substantially a third of the way up the height of the vessel. It may also be located less than substantially a third of the way up the height of the vessel.

In an alternative embodiment the vessel may be comprised of three or more vessel parts; a plurality of watertight joints being provided to join the vessel parts together into a unified vessel.

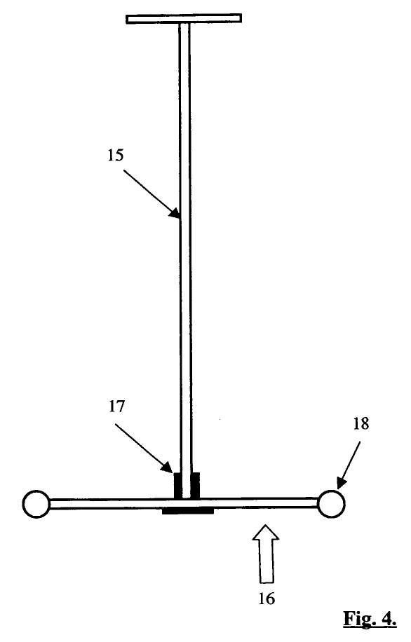

As illustrated in FIG. 4 there is also provided a plunger apparatus comprising a plunger arm 15, a filter apparatus 16 having holes of a size suitable to filter solid beverage flavouring material from a mixture with water, and a joint 17 whereby the filter apparatus 16 and plunger arm 15 can be assembled into a unified plunger apparatus.

Preferably the filter apparatus 16 comprises a frame with a filter element attached thereto. More preferably the filter may be comprised of a wire mesh.

The filter apparatus 16 is adapted to fill a transverse cross-section of the vessel 1, sealing against the inside of the side walls 4a, 4b of the upper and lower vessel parts. Preferably the filter apparatus 16 is provided with a sealing member 18, comprising a resilient material biased outwardly so as to push against the inside of the side walls 4a, 4b. The sealing member 18 may be composed of a rubber material or may comprise an extension of the filter element.

In a preferred embodiment the joint 17 includes a screw mechanism or clip-on mechanism whereby the plunger arm 15 and the filter element 16 may be releasably joined.

In an alternative preferred embodiment the plunger arm 15 and filter element 16 may be permanently joined.

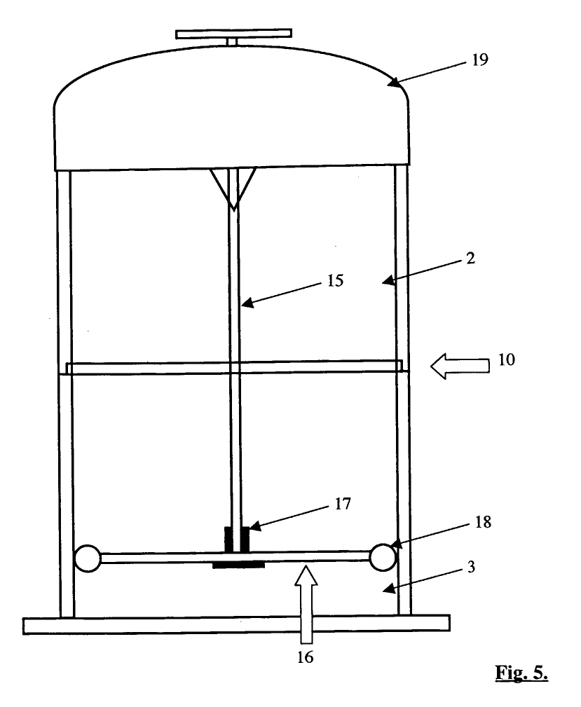

As illustrated in FIG. 5, there is also provided a lid 19 which engages the open upper end 8 of the vessel and which encompasses a portion of the plunger arm 15. The lid 19 engages the upper end of the plunger arm 15 restricting the distance by which it can be pushed into the vessel 1 preventing the filter apparatus 16 from being pushed into contact with the base 5 of the vessel 1.

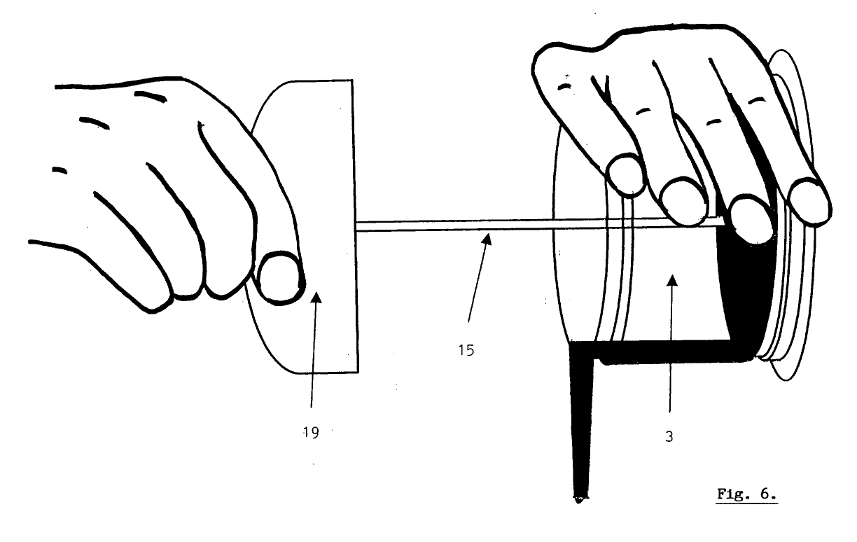

In use, coffee grounds or other solid beverage flavouring material, for instance tea, are mixed together with water in the vessel 1. The plunger apparatus is then pushed into the vessel 1, passing it through the mixture so as to filter out solid material. The filtered beverage is then poured out of the vessel 1, leaving a residue of water and solid material trapped by the plunger apparatus. The plunger apparatus including the lid is then removed from the vessel 1 allowing the upper vessel portion 2 to be disassembled from the lower vessel portion 3. As illustrated in FIG. 6, the plunger apparatus is then inserted into the detached lower vessel portion 3 and is pushed further into the residue present in the lower vessel portion 3, squeezing out excess water and producing a more solid residue.

Preferably there is also provided a handle for convenient handling of the vessel. The handle may be releasably attached to both the upper and lower vessel parts; be permanently joined to one of the vessel parts and releasably joined to the other of the vessel parts; or be joined releasably or permanently to only one of the upper or lower vessel parts. The handle may preferably be integrally formed with one of the vessel parts.

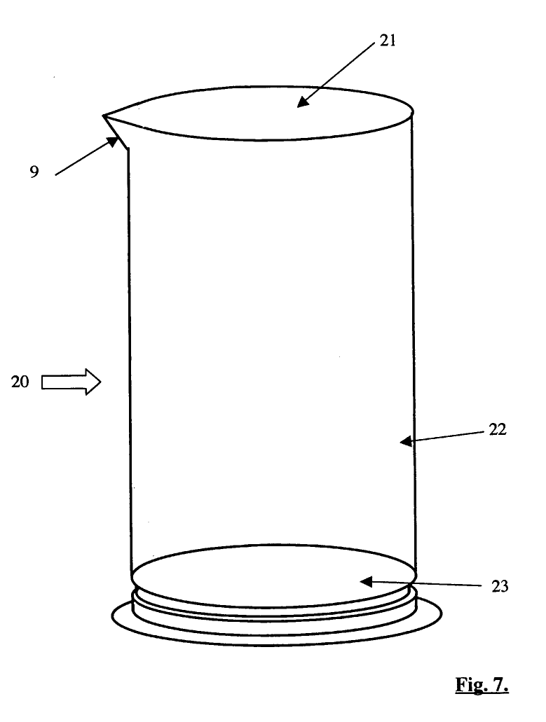

As shown in FIG. 7, in an alternative embodiment of the invention there is provided a vessel 20. The vessel 20 is provided with an open upper end 21, a side wall 22, a closed base 23 and is able to receive and retain fluid. Preferably the vessel 20 also comprises spout portion 9 adapted to aid controllable pouring of fluid from the open upper end 21 of the vessel 20.

In this alternative embodiment a plunger apparatus as shown in FIG. 4 and as described above is provided. The filter apparatus 16 seals against the inside of the side wall 22 of the vessel 20 in the same manner as described in the previous embodiment.

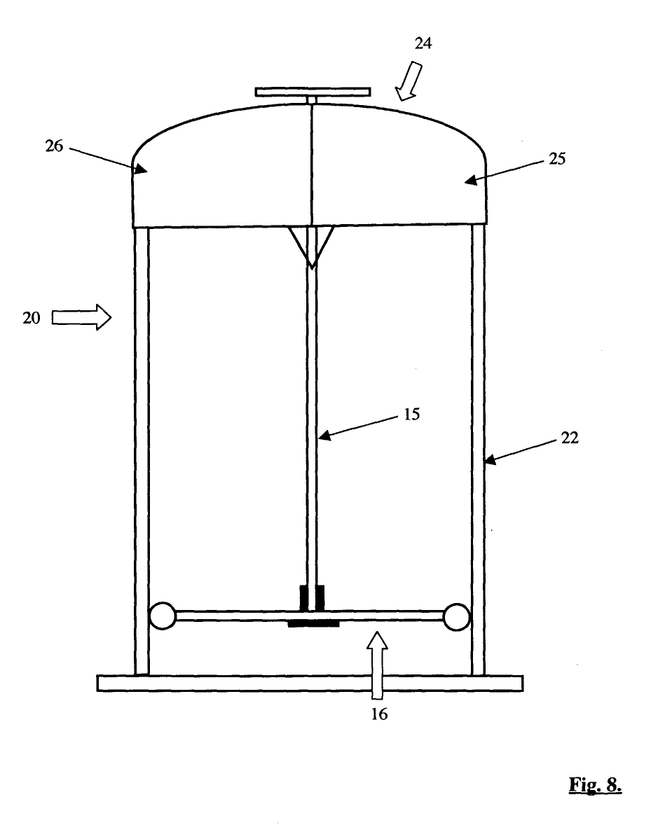

In the present embodiment, as shown in FIG. 8, there is provided a lid 24 which engages the open upper end 8 of the vessel and which is attached to the plunger arm 15. The lid 24 comprises two releasably engaged lid parts 25 and 26. The lid parts 25, 26 join together encompassing a portion of the plunger arm in an aperture 30. When the plunger arm 15 is encompassed in the aperture 30 it is free to reciprocate through the aperture. The lid 24 and aperture 30 act to guide the movement of the plunger arm 15 when it is pushed into the vessel 20. When passed through the aperture in the inward direction the lid 24 will at some point engage the upper end of the plunger arm 15, thus restricting the distance by which it can be pushed into the vessel 20. This prevents the filter apparatus 16 from being pushed into contact with the base 23 of the vessel 20.

When the lid parts 25, 26 are disengaged they allow the plunger arm to be removed from the aperture 30. The lid 24 can then be removed from the vessel 20 and the plunger apparatus 16. Thus the obstruction preventing the plunger arm 15 being pushed further into the vessel 20 is removed and the filter apparatus 16 can be pushed further into the vessel 203 via the plunger arm 15. Preferably the plunger apparatus can be pushed far enough into the vessel 20 to contact the inside base 23.

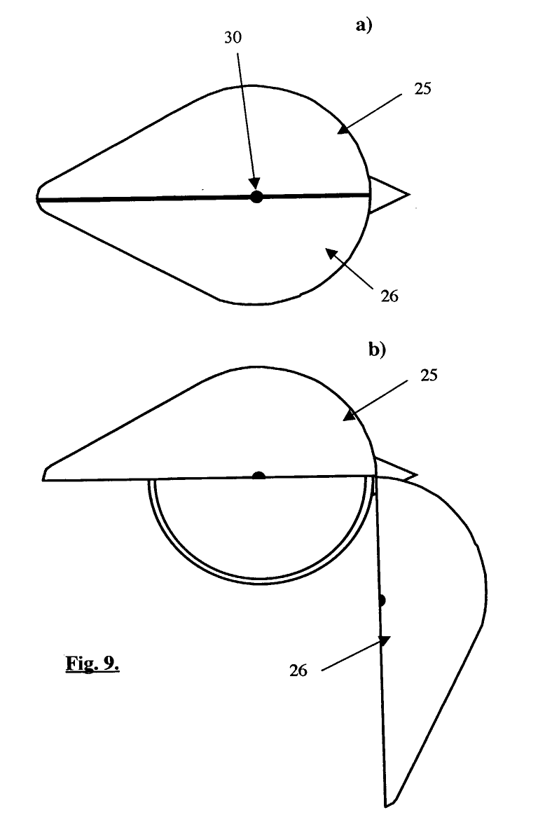

In a preferred embodiment the two lid parts 25, 26 are hinged on one edge as illustrated in FIG. 9 b). In addition to this the lid parts 25, 26 are releasably held together at an unhinged edge by means of a magnetic or clip assembly 29.

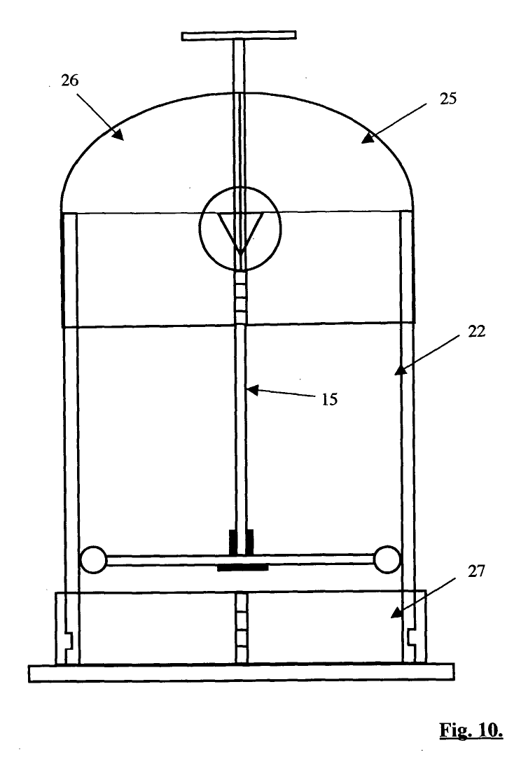

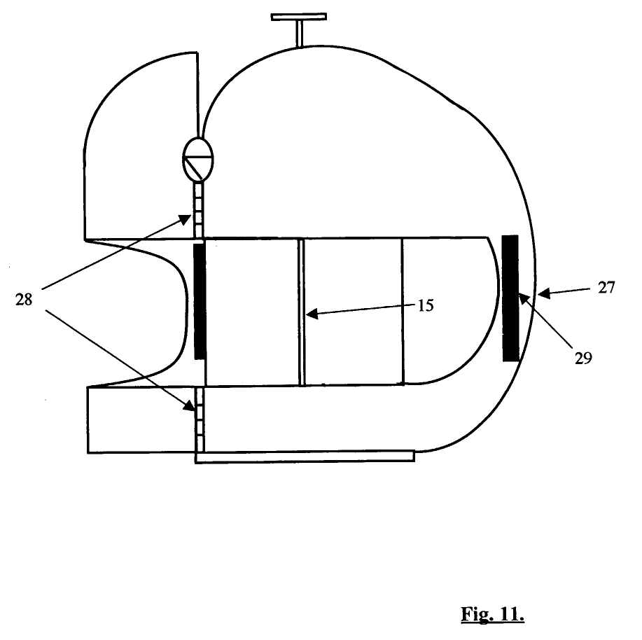

In a further preferred embodiment, illustrated in FIGS. 10 and 11 the lid parts 25, 26 extend downwardly together encompassing a portion of the vessel side wall 22. They also extend down to form a handle 27. The handle 27 encompasses a lower portion of the vessel 20, holding the vessel so that a user can easily handle it.

The handle 27 is composed of two parts each extending from one of the handle parts 25, 26 and is provided with hinges 28 on one edge so that it can be opened to allow removal of the vessel 20 and the plunger arm from the handle and lid.

Preferably the handle parts and lid parts 25, 26 are integrally formed.

Preferably at least one of the lid parts 25, 26 is adapted so that when it engages the open upper end of the vessel 20 a sufficient gap is provided between the top of the vessel and the inside of the lid part 25, 26 to allow the filter apparatus to be inserted into the lid part without disengaging the lid part 25, 26 from the vessel 20.

In use, coffee grounds or other solid beverage flavouring material, for instance tea, are mixed together with water in the vessel 20. The lid 24 or lid 24 and handle 27 are assembled on the vessel 20, then the plunger arm is placed into the aperture 30 and the lid 24 or lid and handle 24, 27 are closed to encompass the plunger arm in the aperture 30. The plunger arm is then pushed into the vessel 20, passing it through the mixture so as to filter out the solid material. The filtered beverage is then poured out of the vessel 20, leaving a residue of water and solid material trapped by the plunger apparatus. The lid 24 or lid and handle combination 24, 27, is then opened and removed from engagement with the vessel 20 and plunger arm 15, allowing the plunger apparatus to be pushed further into the residue, squeezing out excess water.

In an alternative embodiment a lid 19 may be provided with an aperture large enough to allow the top end of the plunger arm to pass therethrough. This allows the lid to be removed from the plunger arm without disassembly of the plunger arm and the filter apparatus. For example the upper part of the plunger arm may be provided with a T-shape handle member and the lid may be provided with a complementary slot adapted to allow the T-shape handle to pass therethrough when appropriately lined up.

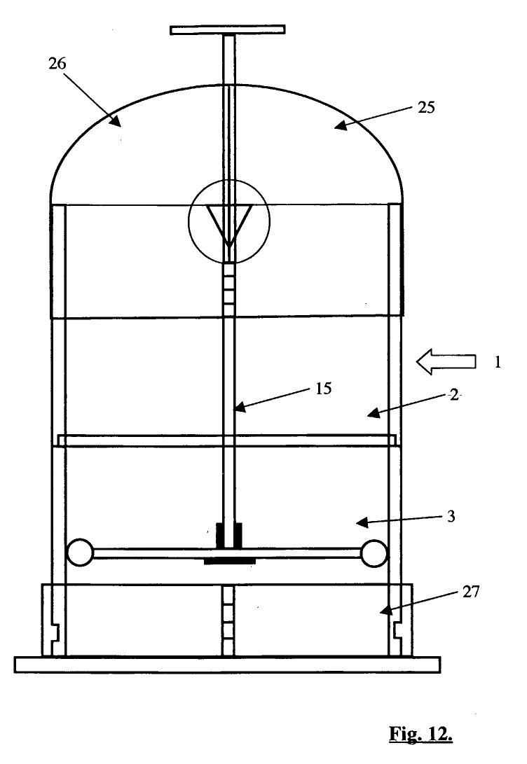

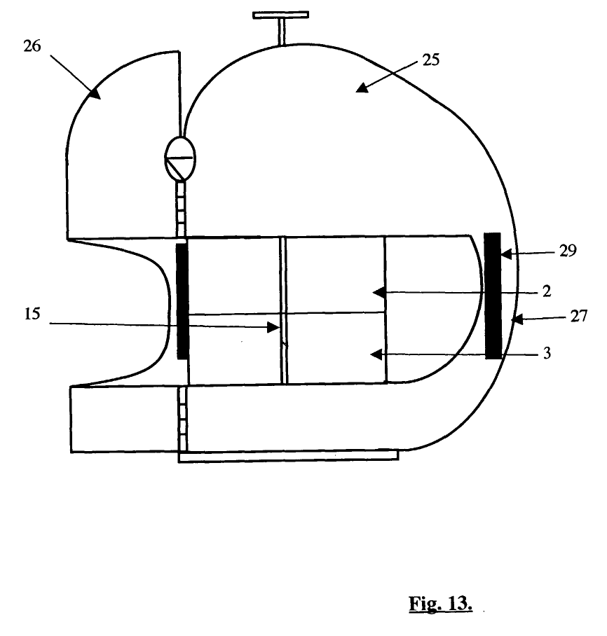

In a preferred embodiment, as illustrated in FIGS. 12 and 13, the vessel 1 comprised of upper and lower vessel parts 2, 3, substitutes the vessel 20 described above. This combines the advantages of having a vessel comprised of releasably engaged upper and lower parts 2, 3 with the advantages of a removable lid 19, 24 or lid and handle combination 24, 27.

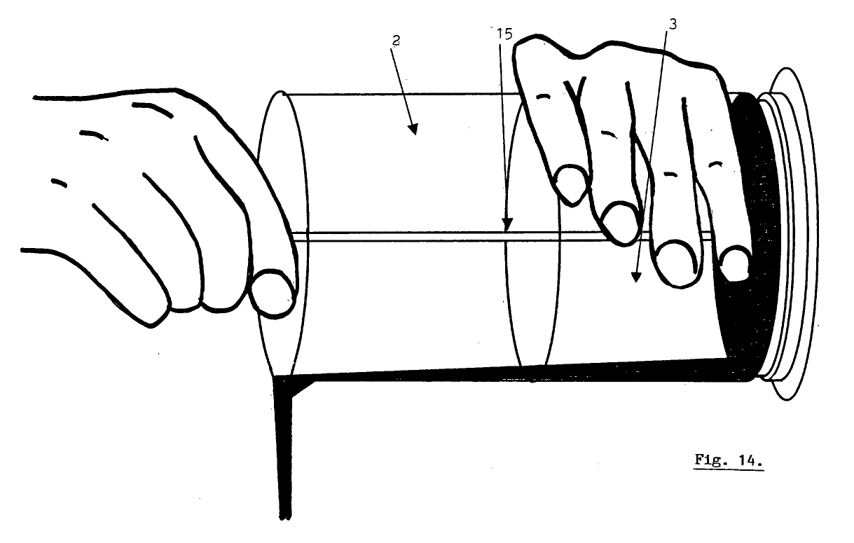

In use, coffee grounds or other solid beverage flavouring material, for instance tea, are mixed together with water in the vessel 1. The lid 24 or lid 24 and handle 27 are assembled on the vessel 1, then the plunger arm is placed into the aperture 30 and the lid 24 or lid and handle 24, 27 are closed to encompass the plunger arm in the aperture 30. The plunger arm is then pushed into the vessel 1, passing it through the mixture so as to filter out the solid material. The filtered beverage is then poured out of the vessel 1, leaving a residue of water and solid material trapped by the plunger apparatus. The lid 24 or lid and handle 24, 27, is then opened and removed from the vessel 1 and plunger arm 15, allowing the plunger apparatus to be pushed further into the residue present in the vessel 1, squeezing out excess water as illustrated in FIG. 14. The plunger apparatus is then removed and the upper vessel portion 2 is disassembled from the lower vessel portion 3 allowing easy access to spoon out the solid residue left in the base of the lower vessel part 3.

1. An apparatus for brewing beverages comprising;
an upper vessel part;
a lower vessel part;
a watertight joint whereby the upper and lower vessel parts can be releasably assembled into a unified vessel, the vessel having an open upper end and a closed lower end; so that when assembled, the vessel can receive and retain fluid therein; and
a plunger apparatus comprising;
a filter apparatus; and
a plunger arm; wherein the plunger arm and filter apparatus are joined or can be joined, so that the filter apparatus can be pushed into the vessel via the plunger arm; and the filter apparatus is adapted to fit into and seal against the inside of the vessel, so that when pushed into the vessel the filter apparatus forms a barrier across the inside of the vessel.

2. An apparatus according to claim 1 wherein, in combination the plunger arm and filter apparatus are taller than the height of the inside of the vessel.

3. An apparatus according to claim 1 wherein the watertight joint comprises complimentary screw threads provided on the upper and lower vessel parts.

4. An apparatus according to claim 3 wherein the watertight joint includes at least one washer.

5. An apparatus according to claim 1 wherein there is provided a lid adapted to engage the open upper end of the vessel and to encompass a portion of the plunger arm, whereby the plunger arm is free to move reciprocally in relation to the lid.

6. An apparatus according to claim 5 wherein the lid is adapted to engage the plunger arm restricting the distance by which it can be pushed into the vessel.

7. An apparatus according to claim 5 wherein the lid covers the open end of the vessel.

8. An apparatus for brewing beverages comprising;
a vessel adapted to retain fluid therein and having an open upper end;
a plunger apparatus comprising;
a filter apparatus;
a plunger arm; and
a lid through which the plunger arm passes; wherein
the plunger arm and filter apparatus are joined or can be joined, so that the filter apparatus can be pushed into the vessel via the plunger arm; and
the filter apparatus is adapted to fit into and seal against the inside of the vessel, so that when pushed into the vessel the filter apparatus forms a barrier a cross the inside of the vessel; and
the lid is adapted so that it can be removed from the plunger arm without disassembly of the filter apparatus and the plunger arm so that when the lid is removed from the plunger arm the plunger apparatus can be pushed into contact with the lower end of the vessel via the plunger arm.

9. An apparatus according to claim 8 wherein the lid covers the open upper end of the vessel.

10. An apparatus according to claim 8, wherein the lid comprises at least two parts adapted to be joined to one another and which are adapted to be able to encompass a portion of the plunger arm when joined together.

11. An apparatus according to claim 10 wherein the lid parts are releasably joined.

12. An apparatus according to claim 10 wherein the lid is provided with at least one magnetic latch adapted to join the lid parts.

13. An apparatus according to claim 10 wherein the lid is provided with hinges joining the lid parts and allowing them to open and close.

14. An apparatus according to claim 10 wherein the lid parts form a handle adapted to encompass a part of the vessel.

15. An apparatus according to claim 6 wherein the lid covers the open end of the vessel.

16. An apparatus according to claim 11 wherein the lid is provided with at least one magnetic latch adapted to join the lid parts.

17. An apparatus according to claim 11 wherein the lid is provided with hinges joining the lid parts and allowing them to open and close.

18. An apparatus according to claim 12 wherein the lid is provided with at least one magnetic latch adapted to join the lid parts.

19. An apparatus according to claim 11 wherein the lid parts form a handle adapted to encompass a part of the vessel.

20. An apparatus according to claim 12 wherein the lid parts form a handle adapted to encompass a part of the vessel.

21. An apparatus according to claim 13 wherein the lid parts form a handle adapted to encompass a part of the vessel.
